(19) United States
(12) Patent Application Publication
(10) Pub. No.: US 2013/0036896 A1
(43) Pub. Date: Feb. 14, 2013

(54) TAMBOURINE AND METHOD FOR PLAYING A TAMBOURINE

(71) Applicant: Floyd L. WASHINGTON, Chicago, IL (US)

(72) Inventor: Floyd L. WASHINGTON, Chicago, IL (US)

(21) Appl. No.: 13/207,524

(22) Filed: Aug. 11, 2011

(51) Int. Cl. G10D 13/02

(52) U.S. Cl. 84/418

(57) ABSTRACT

Tambourines and methods for playing tambourines are disclosed, which may overcome drawbacks inherent to the designs and playing techniques of conventional tambourines and tambourine-like percussion instruments. A tambourine includes a peripheral frame, a plurality of sound producing elements coupled to the frame, a rigid first rod coupled to the frame and extending substantially diametrically across the frame, and one or more rigid additional rods coupled to the first rod. A method for playing a tambourine having a peripheral frame and a plurality of sound producing elements coupled to the frame includes holding the tambourine by gripping a rigid first rod coupled to the frame and extending substantially diametrically across the frame, and by one or more rigid additional rods coupled to the first rod.

### BACKGROUND

Conventional tambourines and other tambourine-like percussion instruments usually consist of a frame with sound producing elements connected in slots around the frame.

The conventional designs of conventional tambourines and tambourine-like percussion instruments, as well as current playing techniques, present several drawbacks.

Typically, a user operates a tambourine by gripping it at an edge of the frame and shaking it. Thus, conventional tambourine designs do not offer additional ways of playing the instrument.

Moreover, the large moment created by holding the frame away from the center of gravity of a conventional tambourine may create discomfort that can lead to rapid tension and fatigue, thus diminishing the amount of time the user can operate the tambourine.

Over time, conventional tambourine use may also cause injury to the tambourine user' hand, wrist, arm, and to other parts of the user's body.

### SUMMARY

An exemplary embodiment of a tambourine may include a peripheral frame, a plurality of sound producing elements coupled to the frame, a rigid first rod coupled to the frame and extending substantially diametrically across the frame, and a one or more rigid additional rods coupled to the first rod.

Another exemplary embodiment of a tambourine may further include padding covering a portion of the first rod, one or more additional rods and/or the frame.

In another exemplary embodiment of a tambourine, any number of the one or more additional rods may be bent.

In another exemplary embodiment of a tambourine, any number of the one or more additional rods may be slidably adjustable along the first rod.

In yet another exemplary embodiment of a tambourine, any number of the one or more additional rods may be revolvably adjustable about the first rod.

In an exemplary method for playing a tambourine having a peripheral frame and a plurality of sound producing elements coupled to the frame, the tambourine may be held by gripping a rigid first rod coupled to the frame and extending substantially diametrically across the frame, and by one or more rigid additional rods coupled to the first rod.

Another exemplary method for playing a tambourine may further include padding covering a portion of the first rod, the one or more additional rods and/or the frame.

In another exemplary method for playing a tambourine, any number of the one or more additional rods may be bent.

In another exemplary method for playing a tambourine, any number of the one or more additional rods may be slidably adjustable along the first rod.

In yet another exemplary method for playing a tambourine, any number of the one or more additional rods may be revolvably adjustable about the first rod.

Other features of the disclosed embodiments will be apparent from the accompanying drawings and from the detailed description which follows.

### DETAILED DESCRIPTION OF THE DRAWINGS

The present embodiments are illustrated by way of example and not limitation in the figures of the accompanying drawings, in which like references indicate similar elements and in which:

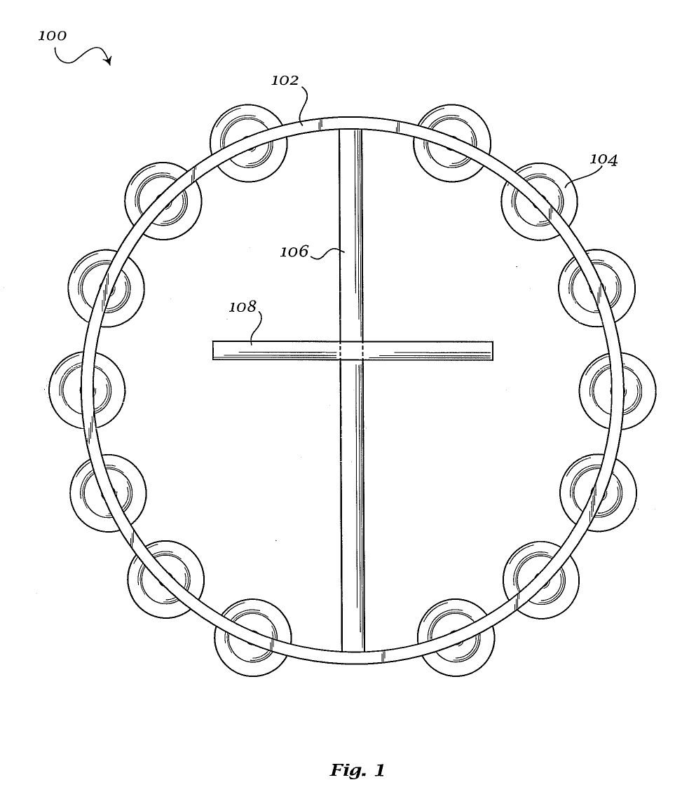

FIG. 1 shows a top view of an exemplary embodiment of a tambourine.

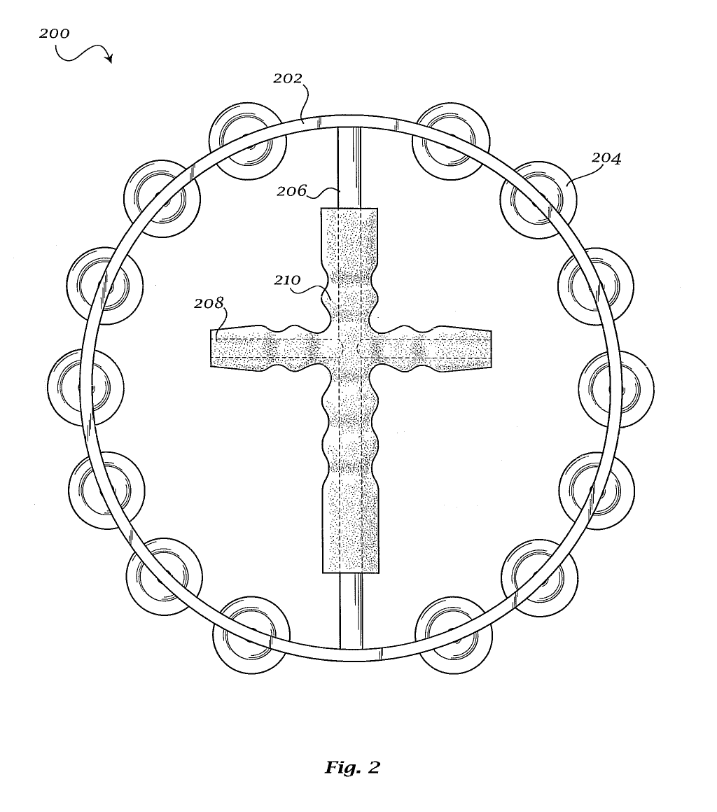

FIG. 2 shows a top view of another exemplary embodiment of a tambourine with padding on a portion of the first rod and the second rod.

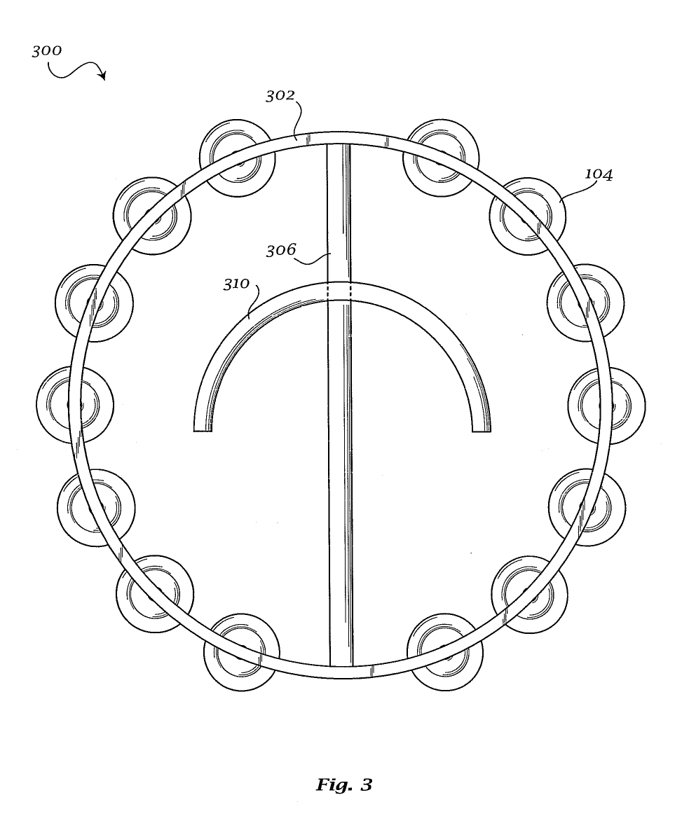

FIG. 3 shows a top view of another exemplary embodiment of a tambourine with a bent second rod.

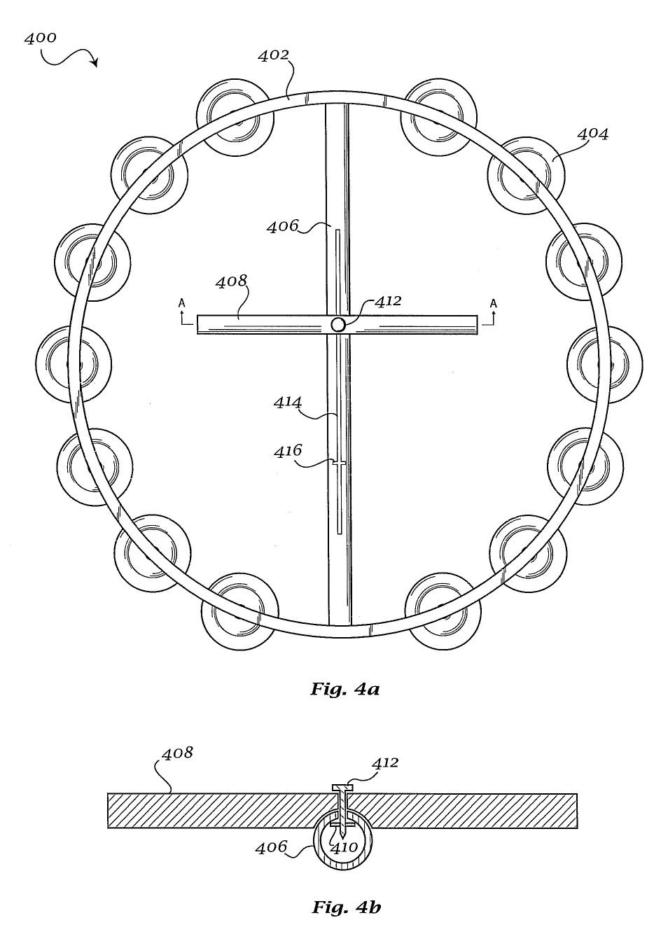

FIG. 4a shows a top view of another exemplary embodiment of a tambourine with a slidably adjustable second rod.

FIG. 4b is a cross-sectional view along line A-A of FIG. 4a.

### DETAILED DESCRIPTION OF THE EMBODIMENTS

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Embodiments disclosed herein describe tambourines and teach methods for playing tambourines, which may overcome drawbacks inherent to the designs of conventional tambourines and tambourine-like percussion instruments, as well as current playing techniques.

The embodiments disclosed herein may provide a user with a variety of novel ways of playing a tambourine. For example, the embodiments disclosed herein may provide new means of holding a tambourine, which may be more comfortable and/or adapted to the user. Furthermore, the embodiments disclosed herein may be applicable to open tambourines, closed tambourines, and tambourine-like percussion instruments.

In addition to providing novel ways of playing a tambourine, the embodiments disclosed herein may allow a user to significantly reduce the discomfort caused by conventional tambourines, and may reduce tension and fatigue, thus increasing the amount of time a user can use a tambourine.

Over time, the embodiments disclosed herein may also significantly decrease the risk of injury to the tambourine user's hand, wrist, arm, and to other parts of the user's body.

FIG. 1 shows an exemplary embodiment 100 of a tambourine. The tambourine may include a peripheral frame 102, a plurality of sound producing elements 104 coupled to the frame, a rigid first rod 106 coupled to the frame 102 and extending substantially diametrically across the frame 102, and a rigid second rod 108 coupled to the first rod 106.

In the exemplary embodiment 100, the frame may be circular, oval, ovoid, polygonal, or of any other frame shape known in the art.

In the exemplary embodiment 100, the sound producing elements 104 may be jingling discs, bells, cymbals, zills, or any other sound producing elements known in the art.

In the exemplary embodiment 100 of a tambourine, the first rod 106 may be glued, welded, fastened by an adhesive, bolted, or otherwise coupled to the frame 102 using any attachment method known in the art.

In the exemplary embodiment 100 of a tambourine, the second rod 108 may be glued, welded, fastened by an adhesive, bolted, or otherwise coupled to the first rod 106 using any attachment method known in the art.

In the exemplary embodiment 100 of a tambourine, the first rod 106 and the second rod 108 may be made of wood, plastic, metal, or of any other rigid material known in the art.

In the exemplary embodiment 100 of a tambourine, the first rod 106 may extend substantially diametrically across the frame 102 so that the user's hand may support the tambourine at or near its center of mass. Holding the tambourine at or near its center of mass may reduce the moment induced on the user's wrist and may avoid the discomfort of conventional tambourines held by the edge of the frame. This design may thus reduce tension and fatigue, and may increase the amount of time a user can use a tambourine. Over time, this design may also significantly decrease the risk of injury to the tambourine user's hand, wrist, arm, and to other parts of the user's body.

FIG. 2 illustrates another exemplary embodiment 200 of a tambourine. Many components of embodiment 200 are the same or similar to those of embodiment 100, and are identified by similar numerals. Such components should be understood to have substantially similar characteristics and functionality in both embodiments. This exemplary embodiment may include a peripheral frame 202, a plurality of sound producing elements 204 coupled to the frame, a rigid first rod 206 coupled to the frame 202 and extending substantially diametrically across the frame 202, a rigid second rod 208 coupled to the first rod 206, and padding 210 covering a portion of the first rod 206 and the second rod 208.

FIG. 3 illustrates another exemplary embodiment 300 of a tambourine. Many components of embodiment 300 are the same or similar to those of embodiment 100, and are identified by similar numerals. Such components should be understood to have substantially similar characteristics and functionality in both embodiments. This exemplary embodiment may include a peripheral frame 302, a plurality of sound producing elements 304 coupled to the frame, a rigid first rod 306 coupled to the frame 302 and extending substantially diametrically across the frame 302, and a rigid, bent second rod 310 coupled to the first rod 306.

FIGS. 4a-4b illustrate another exemplary embodiment 400 of a tambourine. Many components of embodiment 400 are the same or similar to those of embodiment 100, and are identified by similar numerals. Such components should be understood to have substantially similar characteristics and functionality in both embodiments. This exemplary embodiment may include a peripheral frame 402, a plurality of sound producing elements 404 coupled to the frame, and a rigid first rod 406 coupled to the frame 402 and extending substantially diametrically across the frame 402. This exemplary embodiment can also contain flange 410 which can be adjustably and removably fastened to a rigid second rod 408 through the use of a fastener 412. First rod 406 can contain a channel 414 which can be shaped to adjustably retain flange 410. Channel 414 can be shaped in such a manner that, when flange 410 is retained therein while attached to second rod 408, flange 410 and second rod 408 can be adjusted longitudinally along first rod 406, but can be prevented from moving laterally, rotating, or separating from first rod 406. When flange 410 and second rod 408 are located in a desired position, flange 410 and second rod 408 can be tightened against the sides of channel 414 using fastener 412. First rod 406 can also include slot 416, which can intersect channel 414, and which can be sized to facilitate the insertion and removal of flange 410 from channel 414.

In another embodiment of a tambourine, the second rod may be coupled to the first rod by passing the first rod through a hole in the second rod. This design may allow a user to slide the second rod up and down the first rod and/or to revolve the second rod around the first rod. This design may thus allow the user to adjust the position of the second rod to accommodate various ways of using the tambourine. This design may also allow the user to place more weight on one part of his/her hand, thus relieving the tension on another.

Another exemplary embodiment of a tambourine may also include one or more additional rods similar to the second rod, any number of which may be coupled with the first rod in a similar manner to, and at the same time as, the second rod.

An exemplary method for playing a tambourine having a peripheral frame and a plurality of sound producing elements coupled to the frame may include holding the tambourine by gripping a rigid first rod coupled to the frame and extending substantially diametrically across the frame, and by a rigid second rod coupled to the first rod.

Another exemplary method for playing a tambourine may further include padding covering a portion of the first rod, the second rod, and/or the frame.

In another exemplary method for playing a tambourine, the second rod may be bent.

In another exemplary method for playing a tambourine, the second rod may be slidably adjustable along the first rod.

In another exemplary method for playing a tambourine, the second rod may be revolvably adjustable about the first rod.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A tambourine comprising:
a peripheral frame;
a plurality of sound producing elements coupled to the frame;
a rigid first rod coupled to the frame and extending substantially diametrically across the frame; and
one or more rigid additional rods coupled to the first rod.

2. The tambourine of claim 1, further comprising padding covering a portion of at least one of the first rod, the one or more additional rods and the frame.

3. The tambourine of claim 1, wherein any number of the one or more additional rods are bent.

4. The tambourine of claim 1, wherein any number of the one or more additional rods are slidably adjustable along the first rod.

5. The tambourine of claim 1, wherein any number of the one or more additional rods are revolvably adjustable about the first rod.

6. A method for playing a tambourine having a peripheral frame and a plurality of sound producing elements coupled to the frame, comprising:
gripping the tambourine by a rigid first rod coupled to the frame and extending substantially diametrically across the frame, and by one or more rigid additional rods coupled to the first rod.

7. A method for playing the tambourine of claim 6, wherein padding covers a portion of at least one of the first rod, the one or more additional rods and the frame.

8. A method for playing the tambourine of claim 6, wherein any number of the one or more additional rods are bent.

9. A method for playing the tambourine of claim 6, wherein any number of the one or more additional rods are slidably adjustable along the first rod.

10. A method for playing the tambourine of claim 6, wherein any number of the one or more additional rods are revolvably adjustable about the first rod.
